(19) United States
(12) Patent Application Publication
(10) Pub. No.: US 2014/0066144 A1
(43) Pub. Date: Mar. 6, 2014

(54) Waterproof Phone Case

(71) Applicant: Uncommon LLC, Chicago, IL (US)

(72) Inventor: John Hong, Chicago, IL (US)

(73) Assignee: Uncommon LLC, Chicago, IL (US)

(21) Appl. No.: 14/017,881

(22) Filed: Sep. 4, 2013

Related U.S. Application Data
(60) Provisional application No. 61/697,130, filed on Sep. 5, 2012.

(51) Int. Cl. H04M 1/18

(52) U.S. Cl. CPC H04M 1/18
USPC 455/575.8

(57) ABSTRACT

A waterproof case intended to protect an electronic device from harm caused by exposure to material, such as dirt, dust and water. Generally, the case includes a shell having front and back panels, peripheral sidewalls on three sides, and an opening on a fourth side defined by edges of the shell. A fourth sidewall is attached to the shell, via a hinge, and is configured to seal the opening of the shell. A latch secures the fourth sidewall in a closed position as well. A lock may be used to engage the latch to prevent unintended unlatching of the sidewall. Further, as it is intended that the phone be fully functional while stored in the waterproof case, at least one button interface is positioned on a peripheral sidewall to permit operation of phone features, such as placing and receiving calls, photographing, game operation and control, etc.

### RELATED APPLICATIONS

The present application claims the filing priority of U.S. Provisional Application Ser. No. 61/697,130 titled “Cases For Electronic Devices” and filed Sep. 5, 2012. The '130 application is hereby incorporated by reference.

### TECHNICAL FIELD OF THE INVENTION

The present invention relates to cases for electronic devices. More specifically, the invention relates to a waterproof case for an electronic device, such as a smart phone. Even more specifically, the invention relates to a waterproof case for housing an electronic device, such as a smart phone, without loss of functionality.

### BACKGROUND OF THE INVENTION

Mobile phone cases have very quickly blossomed into a multi-billion dollar industry. With each new entry into the field, phone cases become lighter, stronger, more colorful, more securable, but they never seem to become more functional. That is, phone case designers and manufacturers have focused solely on the primary purpose of a phone case—i.e., to protect the phone within. In fact, the protective phone case has become such a necessary component of the phone itself, case manufacturers are often given new phone details well-ahead of the general public so that such cases are available as soon as a new phone reaches store shelves.

However, other than aesthetic differences, phone case providers have been unable to point to any meaningful improvements or advantages they provide over cases made by other manufacturers. As a result, purchases of phone cases are typically made based on aesthetic appeal alone.

But problems with phone cases, such as water/moisture damage, poor or low sound quality, and limited screen viewability, have persisted. Where such problems have been addressed, the proffered solution is the use of a peripheral device. Added components detract from the portability of the phone, which is probably the feature which is most responsible for mobile phone popularity.

Perhaps the biggest problems for today's mobile phone users are the “elements”. That is, water, dirt and dust can cause all kinds of performance problems. Finding a way to protect a phone from these elements while still providing functionality.

Until the invention of the present application, many phone case manufacturers have placed style ahead of substance. The present invention solves these and other problems in the prior art which went either unnoticed, ignored or unsolved by those skilled in the art. The present inventions provide external speakers which perform multiple functions with the associated electronic device without sacrificing portability features, designs, style or affordability.

### SUMMARY OF THE INVENTION

There is disclosed herein an improved case for an electronic device which avoids the disadvantages of prior devices while affording additional structural and operating advantages.

Generally speaking, the disclosed case is intended to protect an electronic device, such as a phone, from harm caused by exposure to undesired material, such as dirt, dust and water. An embodiment of the case is comprised of a shell having front and back panels, peripheral sidewalls on three sides, and an opening on a fourth side defined by edges of the shell. A fourth sidewall is attached to the shell, via a hinge, and is configured to open and sealably close over the opening of the shell. A latch for securing the fourth sidewall in a closed position over the opening is positioned on the shell as well.

In an embodiment of the case, a lock is used to engage the latch to prevent unintended unlatching of the sidewall.

Further, it is intended that the phone be fully functional while stored in the waterproof case. As such, at least one button interface is positioned on a peripheral sidewall to permit operation of phone features, such as placing and receiving calls, photographing, game operation and control, etc. A speaker interface may also be positioned on the front panel of the shell to permit sound to travel outside the case.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a rear perspective view of an embodiment of the disclosed phone case;

FIG. 2 is a front view of the embodiment of FIG. 1;

FIG. 3 is a rear view of the embodiment of FIG. 1;

FIG. 4 is a side view of the embodiment of FIG. 1;

FIG. 5 is another side view of the embodiment of FIG. 1;

FIG. 6 is a top view of the embodiment of FIG. 1;

FIG. 7 is a bottom view of the embodiment of FIG. 1;

FIG. 8 is another bottom view of the embodiment of FIG. 1, eliminating a bottom sidewall to show an opening;

FIG. 9 is a perspective view of the pivoting sidewall of an embodiment of the disclosed case in an open position;

FIG. 10 is another perspective view of the pivoting sidewall of FIG. 9 in an open position;

FIG. 11 is a perspective view of the pivoting sidewall of FIG. 9 a closed position and unlatched condition;

FIG. 12 is a perspective view of the pivoting sidewall of FIG. 11 in a closed and clasped condition;

FIG. 13 is another perspective view of the pivoting sidewall of FIG. 12 in a closed and clasped position;

FIG. 14 is a perspective view of an interior surface of a pivoting sidewall;

FIG. 15 is rear view of the camera lens and flash openings of an embodiment of the disclosed case; and

FIG. 16 is rear view of a selection interface on a front panel of an embodiment of the disclosed case.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

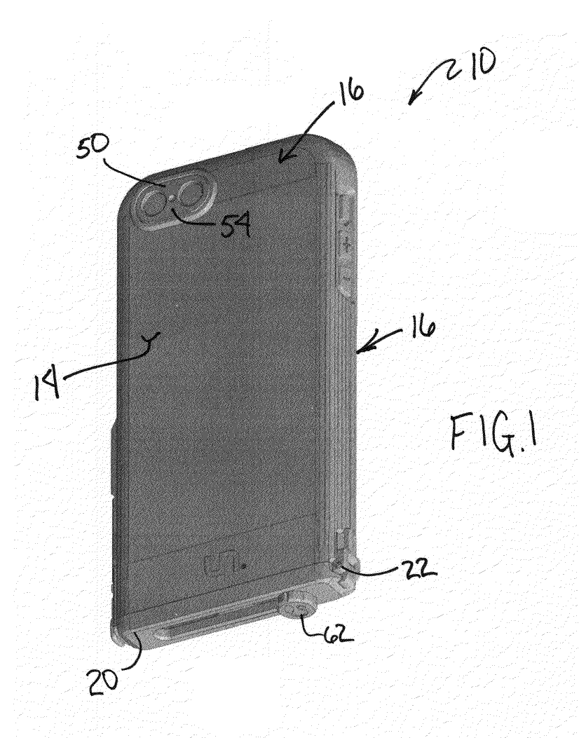

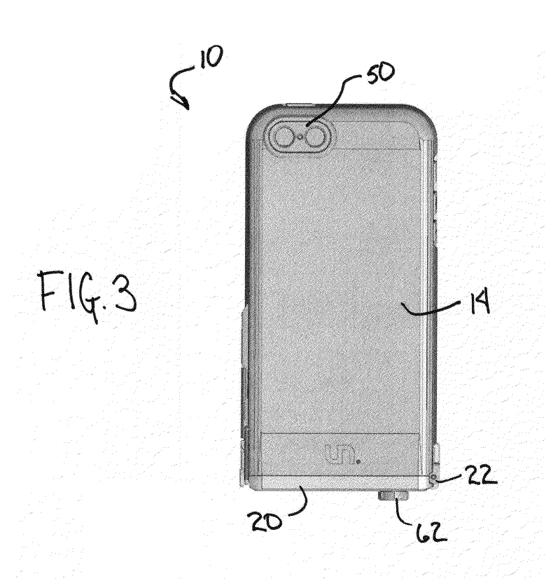

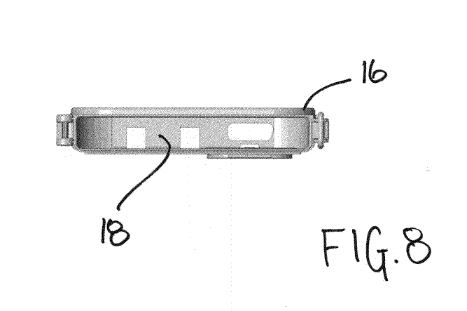

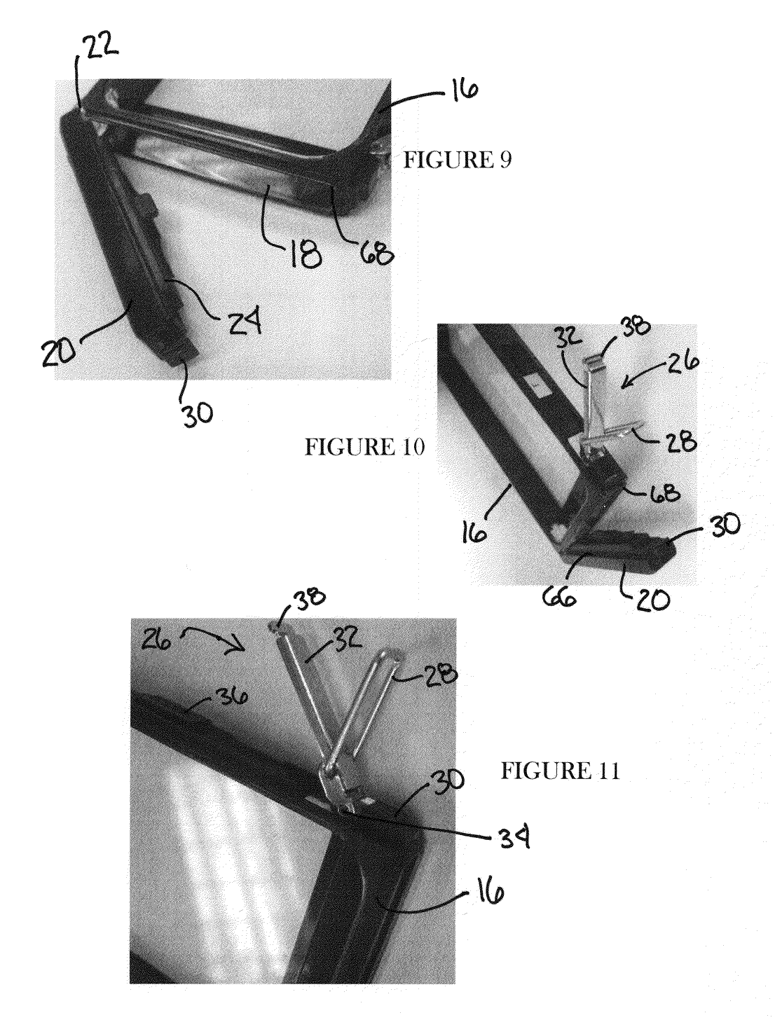

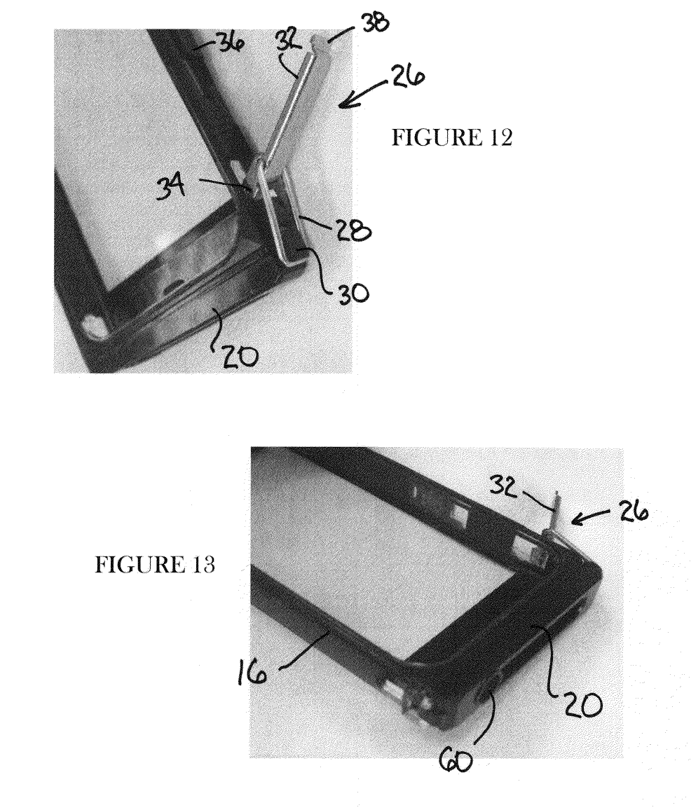

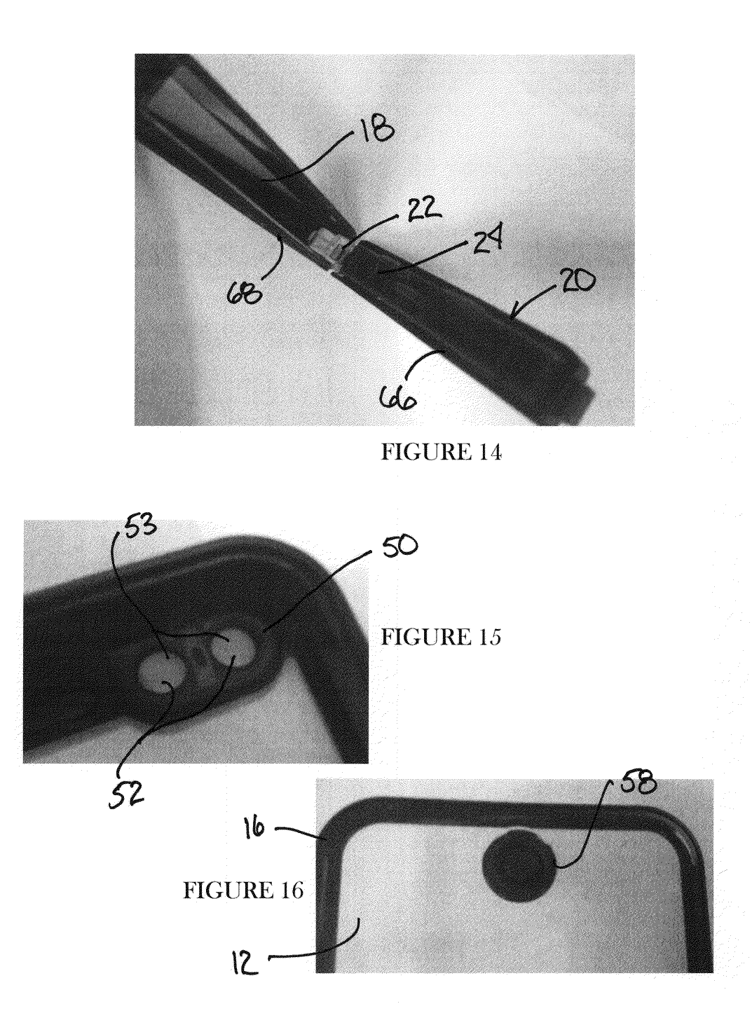

Referring to FIGS. 1-16, there is illustrated a case, generally designated by the numeral 10. The particular illustrated case 10 is for a phone, specifically for an iPhone® 5 smart phone, designed and manufactured by Apple Corp. of Cupertino, Calif. In fact, while all the embodiments illustrated are directed to an iPhone , it should be understood that the principles of the invention can be more broadly applied to most mobile phones, as well as many other types of electronic devices such as recorders, PDA, gaming devices, and the like, as long as they might benefit from being protected from the elements.

As can be seen in FIGS. 1-3, the case 10 is comprised of a transparent front panel 12, a back panel 14 and a frame 16 which seals against an outer peripheral edge of each panel. To provide the desired “waterproof” seal, the entire peripheral edges of the panels, 12 and 14, seal against an inside surface of the frame 16. The panels 12, 14 may be adhered in any known and suitable manner.

As shown in FIGS. 8, 9 and 14, the frame 16 includes an opening 18 defined within a bottom side of the frame 16. The opening 18 is to allow the insertion of an electronic device (not shown) into the case 10. A pivoting sidewall 20 is attached by a hinge 22 to the frame 16 and is configured to seal against the periphery of opening 18. The sidewall 20 is capable of pivoting between an open position (i.e., the frame opening is uncovered) and a closed position (i.e., the frame opening is covered). A gasket 24, or other sealing member, may be used on an internal surface of the sidewall 20 to securely seal out moisture and the like.

As shown in FIGS. 10-13, a latch 26 attached to the frame 16 is used to retain the sidewall 20 in the closed position, when desired. The latch 26 moves between a latched and unlatched position and includes a clasp 28, which is used to loop about a tab 30 on the sidewall 20, and a pivoting bar 32 coupled to the clasp 28. As the bar 32 moves on its pivot 34 into the unlatched position, the clasp 28 is capable of engaging the sidewall tab 30. As the bar 32 moves back toward the latched position, the clasp 28 pulls the sidewall 20 into a sealing relationship with the frame 16.

A lock 36 may be included to engage the latch 26 (i.e., the pivoting bar 32) when in the latched position. The lock 36 comprises a sliding bar secured to the frame 16 and is movable between a locked and unlocked position. A small flange or tab 38 on the pivoting bar 32 of the latch 26 is engaged by the lock 36 when moved to the locked position to thereby prevent the latch 26 from moving to the unlatched position.

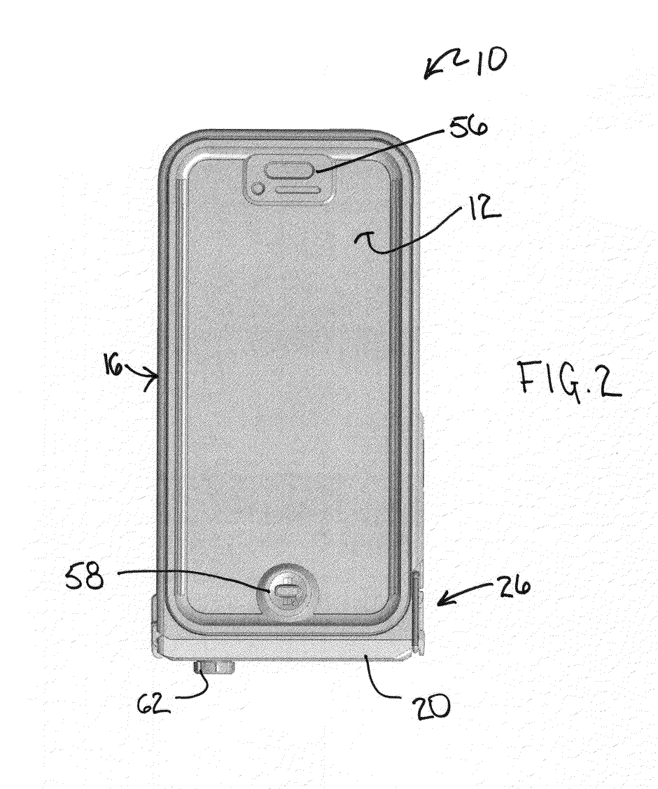

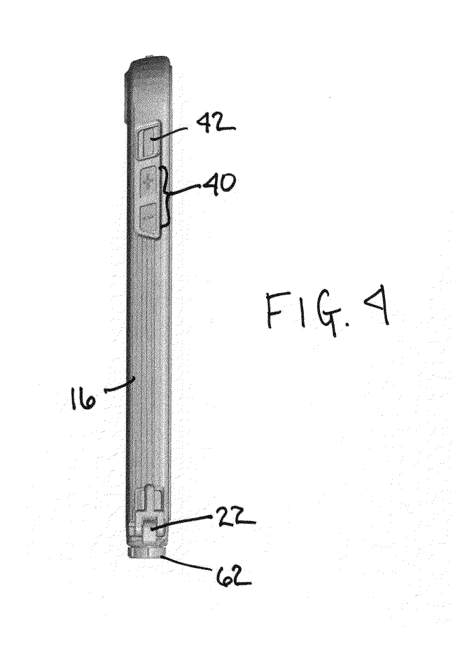

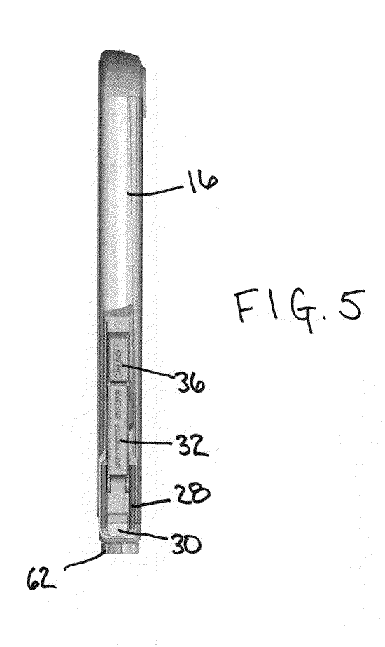

As shown in FIGS. 2, 4 and 6, the case 10 further comprises multiple button interfaces positioned on the frame 16 and panels 12, 14. Specifically, the side view shown in FIG. 4 includes volume and mute interface buttons 40, 42, respectively, which are positioned to correspond to the volume controls of an iPhone® 5. FIG. 6 also shows the “on/off” power button interface 44. These interface “buttons” are comprised of a rubber or flexible polymer material having a thicker inner surface which contacts the corresponding phone button feature.

Further, as shown in FIGS. 1, 2, 15 and 16, there is a separate interface for each of a speaker, a select button and a camera (lens and flash) on one of either the front or back panels, 12 and 14. These interfaces are positioned to correspond with the related components on a particular phone (e.g., iPhone® 5). In the case of the camera interface 50, separate openings 52 are provided on a portion of the frame 16 which secures the back panel 14. Each of the openings 52 is sealed by a transparent overlay 53 which is held in place by an opaque overlay 54 fixed to the frame 16. The transparent overlay 53 covers the openings 52 from an exterior surface to prevent water ingress into the case 10 while still permitting unimpeded operation of the camera lens and flash features. Of course, the openings 52 may be sealed in other ways as well, especially for other phone designs which may differ from the example shown.

As to the speaker and select button interfaces, 56 and 58, respectively, these components are made of a resilient polymer known in the art and are formed to seal on each side of an opening (not shown) on the front panel 12. The speaker interface 56 allows sound to pass through, while the select button interface 58 provides a thicker area on the interior which can be pushed into contact with the phone's selection button. Of course, other means for the interfaces can be used, particularly for other phones which may have different designs and requirements.

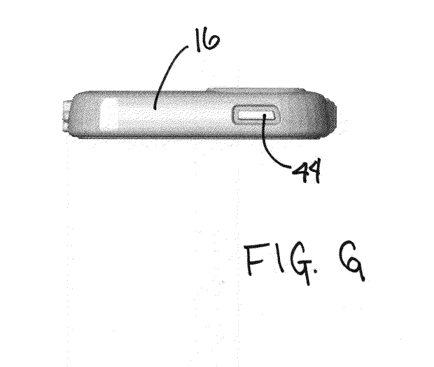

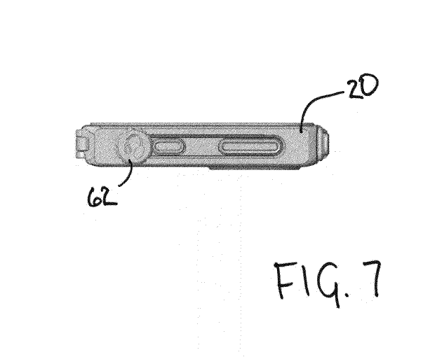

Referring now to FIGS. 7 and 10-13, the bottom, pivoting sidewall 20 of the case 10 is shown more clearly. The sidewall 20 preferably includes an earphone port 60 for accommodating an earphone plug (not shown). The port 60 is comprised of a threaded opening which aligns with the female connector of the phone. To seal the port 60, a threaded plug 62 can be screwed into the threaded opening.

The interior of the pivoting sidewall 20 is preferably equipped with a rubber or flexible polymer gasket 24 to seal against the bottom of a phone (not shown) when closed. The gasket 24 forms a thin channel 66 along the immediate interior edge of the pivoting sidewall 20. A slight extending rim 68 is preferably formed along the interior surface of the opening 18 of the frame 16. When the sidewall 20 is closed, the rim 68 inserts into the channel 66 to effectively seal the interior of the case 10 from the ingress of water and other undesired material.

In use, the case 10 is able to seal the interior environment from the ingress of water and other undesired material for at least a period of time. Further, while sealed in the case 10, a phone is able to provide full function of all features, including screen touch for operation of apps, music playing, and camera features, as well as placing and receiving calls.

To use the case 10, the lock 36 should be placed in the “unlocked” position. Then, the latch 26 is capable of being pivoted to unlatch the clasp 28 from the tab 30 of the pivoting sidewall 20. The sidewall 20 can then be pivoted to an open position to allow an appropriate phone to be slid into the case 10 through the opening 18. The sidewall 20 can then be closed, latched and locked, to seal the phone within the case 10. To remove the phone, the process is repeated with the phone being removed from the opening 18.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A waterproof case for enclosing an electronic device, the case comprising:
a shell having front and back panels, peripheral sidewalls on three sides, and an opening on a fourth side defined by edges of the shell;
a fourth sidewall hingeably attached to the shell and configured to open and sealably close over the opening; and
a latch for securing the fourth sidewall in a closed position over the opening.

2. The waterproof case of claim 1, further comprising a gasket attached to the fourth sidewall for sealing against a periphery of the opening.

3. The waterproof case of claim 1, wherein the latch is positioned on a peripheral sidewall of the shell.

4. The waterproof case of claim 3, further comprising a lock to engage the latch.

5. The waterproof case of claim 4, wherein the latch comprises a pivoting bar having a flange and the pivoting bar moves between an unlatched and latched position, and the lock is a slideable bar which is capable of engaging the flange when the pivoting bar is in the latched position.

6. The waterproof case of claim 1, further comprising at least one button interface positioned on a peripheral sidewall.

7. The waterproof case of claim 1, further comprising a speaker interface positioned on the front panel of the shell.

8. The waterproof case of claim 1, further comprising a camera lens interface window positioned on the back panel of the shell.

9. The waterproof case of claim 8, further comprising a camera flash interface window positioned on the back panel of the shell.

10. The waterproof case of claim 1, wherein the front panel is transparent.

11. The waterproof case of claim 1, further comprising an earphone port defined in the fourth sidewall.

12. The waterproof case of claim 11, further comprising a plug for sealing the earphone port when not in use.

13. A waterproof case for an electronic device, the case comprising:
a transparent front panel having a peripheral edge;
a back panel having a peripheral edge;
a frame sealingly engaging each of the front panel and the back panel along the entirety of their respective peripheral edges, and having an opening defined within a side of the frame;
a pivoting sidewall attached by a hinge to the frame and configured to seal against the opening; and
a latch attached to the frame and comprising a clasp for engaging the pivoting sidewall, wherein the latch moves between a latched position and an unlatched position to secure and release, respectively, the pivoting sidewall in a sealed position.

14. The waterproof case of claim 13, further comprising a lock to engage the latch.

15. The waterproof case of claim 14, wherein the latch further comprises a flange and the lock is a slideable bar capable of sliding to engage the flange when the latch is in the latched position.

16. The waterproof case of claim 13, further comprising at least one button interface positioned on the frame.

17. The waterproof case of claim 13, further comprising a speaker interface positioned on the front panel.

18. The waterproof case of claim 13, further comprising a camera lens interface window positioned on the back panel.

19. The waterproof case of claim 18, further comprising a camera flash interface window positioned on the back panel.

20. The waterproof case of claim 13, further comprising an earphone port defined in the fourth sidewall.

21. The waterproof case of claim 20, further comprising a plug for sealing the earphone port when not in use.

22. The waterproof case of claim 13, further comprising a gasket attached to the pivoting sidewall for sealing against a periphery of the opening.
